(19) United States
(12) Patent Application Publication
(10) Pub. No.: US 2018/0176155 A1
(43) Pub. Date: Jun. 21, 2018

(54) SIMULTANEOUS DATA COMMUNICATIONS VIA MULTIPLE MOBILE CHANNELS

(71) Applicant: SoukTel, Inc., Newark (DE)

(72) Inventor: Michael Moszczynski, Toronto (CA)

(21) Appl. No.: 15/380,421

(22) Filed: Dec. 15, 2016

(51) Int. Cl. H04L 12/58; H04W 4/14

(52) U.S. Cl. CPC H04L 51/04; H04L 51/32; H04W 4/14

(57) ABSTRACT

Simultaneous data collection and content delivery via channels including mobile messaging applications, Short Message Service (SMS) and interactive voice response (IVR) is provided. According to various embodiments, a message is read. A list of recipients is read. A profile is read for each recipient in the list of recipients. Each profile comprises at least one channel identifier. A channel is selected for each recipient in the list of recipients based on its profile. The message is transformed according to the selected channel for each recipient in the list of recipients. The transformed message is sent to each recipient in the list of recipients according to the selected channel.

### BACKGROUND

Embodiments of the present disclosure relate to mobile data collection, and more specifically, to simultaneous data collection/content delivery via mobile messaging application, Short Message Service (SMS) and interactive voice response (IVR).

### BRIEF SUMMARY

According to various embodiments of the present disclosure, methods of and computer program products for communications via multiple mobile channels are provided. A message is read. A list of recipients is read. A profile is read for each recipient in the list of recipients. Each profile comprises at least one channel identifier. A channel is selected for each recipient in the list of recipients based on its profile. The message is transformed according to the selected channel for each recipient in the list of recipients. The transformed message is sent to each recipient in the list of recipients according to the selected channel.

### BRIEF DESCRIPTION OF THE SEVERAL VIEWS OF THE DRAWINGS

FIG. 1 illustrates a channel selection method according to various embodiments of the present disclosure.

FIG. 2 illustrates a user interface for the design of rich messages according to various embodiments of the present disclosure.

FIG. 3 illustrates a user interface for defining channel rules according to various embodiments of the present disclosure.

FIG. 4 illustrates a method of communication via multiple mobile channels according to various embodiments of the present disclosure.

FIG. 5 depicts a computing node according to an embodiment of the present invention.

### DETAILED DESCRIPTION

With the rise of internet connectivity across multiple devices, users now often have a variety of different channels through which they can communicate, both receiving and transmitting messages. For example, a single smart phone may have access to SMS, MMS, a microblogging service, a social network, an enterprise message platform, and a personal message platform in addition to having the ability to place and receive phone calls. In some environments, however, not all such channels are available continuously, and thus the most efficient method of delivering a message to a particular user may vary at different points in time. Accordingly, there is a need for systems and methods for sending messages that allow for the optimization of channels while the sender remains agnostic as to the channel the recipient ultimately uses.

Various potential solutions to this problem place the responsibility to choose the channel on the sender. However, the sender often has no direct contact with the recipient and cannot determine the most appropriate channel.

In addition, there are multiple criteria on which the preferred channel can be based. For example, channel selection may be based on channel connectivity or channel capability—whether the channel is likely to be connected and whether a channel supports rich media. As an example, the sender may want to send an image, but some users have better connectivity on channels that support only text. In such a case, there may be a choice to switch to the text-only channel, resulting in a higher likely reception rate, or to insist on the visual channel, ensuring the fullness of the message. Manually selecting a channel for each user in such cases is impractical.

Various potential solutions may assume an always-on or always-off environment, resulting in a consistent bias toward either channel connectivity or capability. However, some channels, e.g., messenger applications such as Facebook Messenger or WhatsApp, report a user's online status which is available to choose between multiple delivery channels.

According to various embodiments of the present disclosure, systems and methods are provided for selecting delivery channels that allow the sender to remain channel-agnostic while nevertheless maximizing the information delivered to users while balancing number of recipients against the richness of the message. In various embodiments, a decision is made as to the appropriate channel for message delivery based on a number of factors including, e.g., online status, stated preference, previous message delivery reports, known available channels, channel capability, and/or sender weighting of the maximizations (e.g., by applying a separate priority to channel connectivity or channel capability). Various embodiments also allow a determination of bandwidth availability, for example by use of a ping that does not consume metered data but that provides an indication of the recipient's bandwidth capacity (e.g., reporting back that a high-bandwidth channel is available). For two-way communication, responses may be sent on the same channel as the received message, and incoming data may be aggregated channel-agnostically for each user.

The systems and methods of the present disclosure have extensive applicability in environments where the internet is not omnipresent or reliable. Users in such environments are likely to transition frequently between high-bandwidth, low-bandwidth, cellular-only, and no-connectivity environments. The present disclosure enables the optimization of channels for reaching such users.

In various embodiments, a database of users is maintained. Each user can have one or more communication channels designated. These channels may include, e.g., SMS, voice, or online messaging applications, as well as any other digital channels that may become available in the future. A sender writes a message, selects target users, and determines a relative priority for the richness of the image and the probability of reception.

When the message is sent, the channels used are determined by the methods set forth herein without manual designation by the sender. The sending behavior may be based on a plurality of rules in a rulebase. In an exemplary embodiment, if a messaging platform shows that a user has been inactive for a predetermined period of time (e.g., a day, a week), that channel is not used; if a channel shows activity but results in a delivery failure, a different channel is tried. If a sender has assigned a high priority to channel capacity, channels that do not support the full rich information of a given message are ignored. The rules may be applied separately for each user, and may have different results at different times.

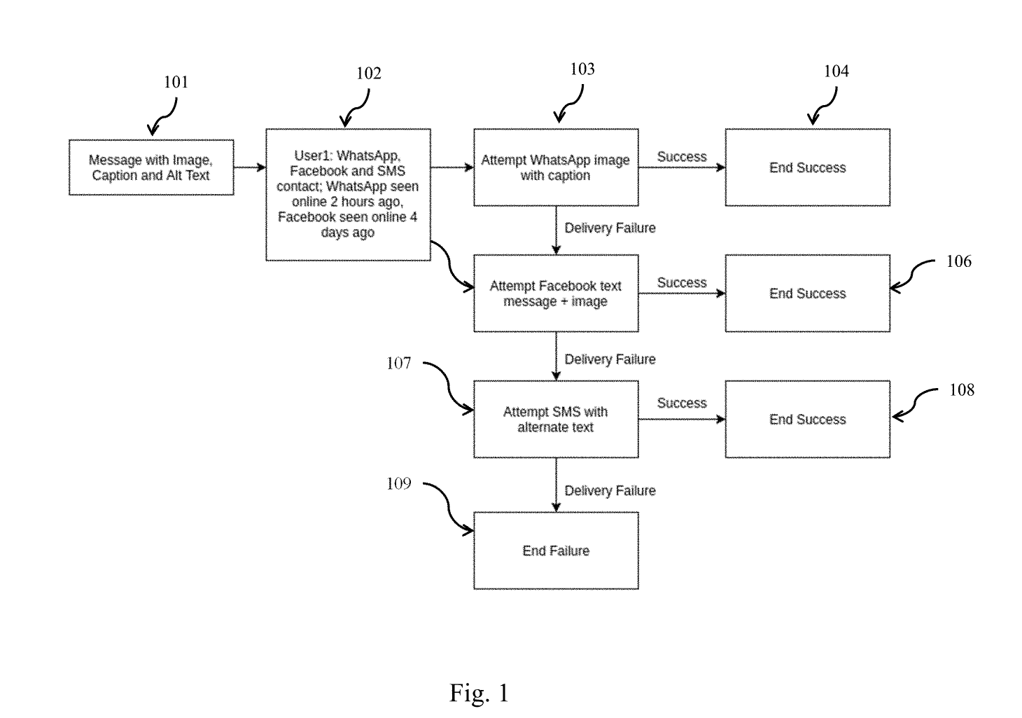

With reference now to FIG. 1, an exemplary channel selection method is illustrated according to various embodiments of the present disclosure.

At 101, a message is generated or received from a sender. In this exemplary embodiment, the message includes an image, a caption, and alt text for the image. However, it will be appreciated that the present disclosure is applicable to a variety of content types and message complexity. At 102, a first user profile is read to determine available channels. In this example, the first user profile indicates that the first user is available through the WhatsApp messaging platform, the Facebook social network, and via SMS, but was most recently active on the WhatsApp messaging platform. At 103, an attempt is made to send the image and caption via the WhatsApp messaging platform, it being the platform on which the user was most recently marked as online. If message delivery is successful, the process completes at 104. If there is a delivery failure, an attempt is made to send the image and caption via the Facebook social network at 105, it being the only other available channel that supports image delivery. If message delivery is successful, the process completes at 106. If there is a delivery failure, an attempt is made to send the alt text via SMS at 107, it being the only remaining channel available for the user. In this case, the alternate text is used in place of the image, as the SMS channel does not support images. If message delivery is successful, the process completes at 108. If there is a delivery failure, the process terminates at 109.

It will be appreciated that each individual channel may have separate capacities. With reference to the above, for example, SMS supports only text and so alt text is sent in place of an image. It will also be appreciated that different channels provide capability detection, such that a channel may be pre-checked for its capabilities prior to sending a message.

In various embodiments, various attributes of the channels are used to determine the order in which they are tried. For example, factors considered may include online status, stated preference, previous message delivery reports, known available channels, channel capability, and sender priority with respect to capability and connectivity. Multiple data points over time also allow the system to create a bandwidth profile of a given user, indicating a relationship between bandwidth and time. For example, a given user may have high bandwidth during working hours, low bandwidth in evenings, and none on weekends. Such a case may be typical of someone who works in a city during the week but visits his family in a separate region on weekends. This profile allows a more intelligent optimization based not only on current conditions but previous patterns.

To take full advantage of channel selection, a sender should provide a message that is compatible with various potential channels. As such, a sender wanting to send an image should add a caption as well as an alternate text that is different from the caption and can act as a replacement for the image in a text-only channel. Similarly, images should be provided that can replace videos in low-bandwidth environments.

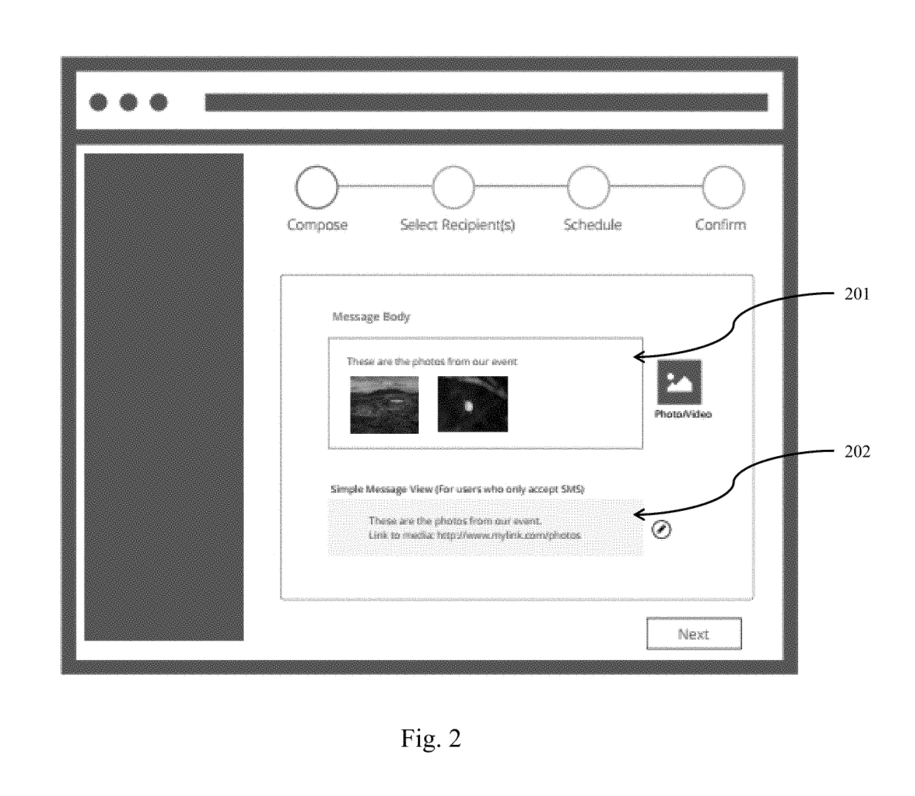

With reference now to FIG. 2, an exemplary user interface for the design of rich messages is illustrated according to various embodiments of the present disclosure. A message body 201 is input by a user. In this example, the message body includes images and text. In order to accommodate text-only channels, the user is prompted to input a simple message 202 as well. In this example, the user has input a URL in place of the images. However, it will be appreciated that in some cases, a text description or other substitute for the images may be included.

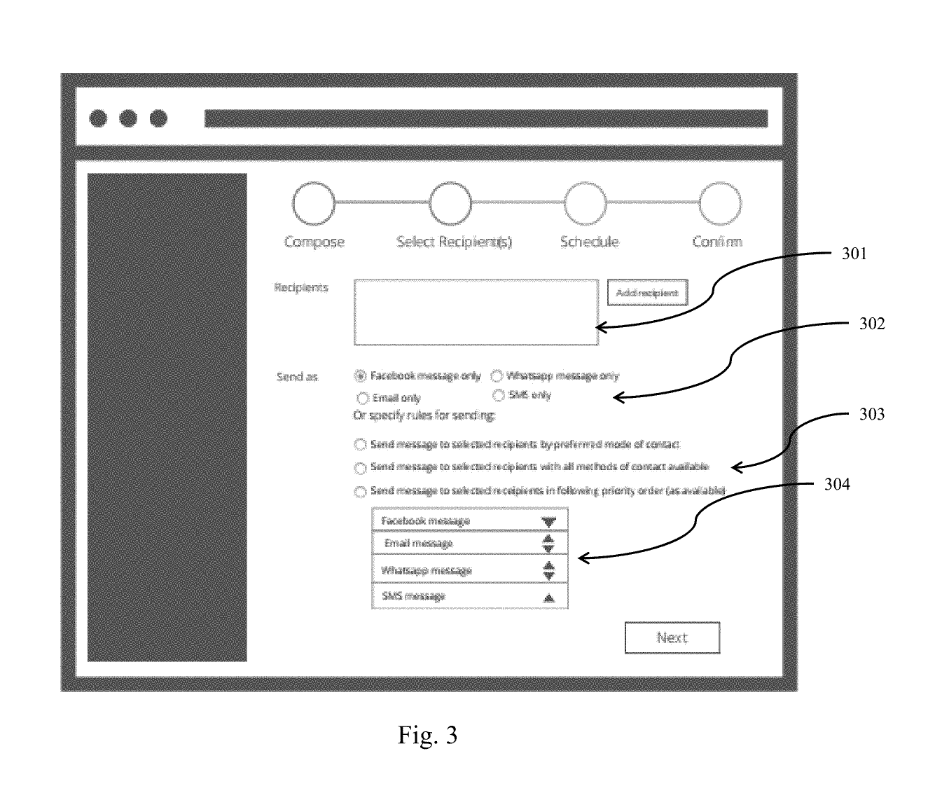

With reference not to FIG. 3, an exemplary user interface for defining channel rules is illustrated according to various embodiments of the present disclosure. A sender may designate recipients 301. It will be appreciated that a variety of recipient selections suitable for use according to the present disclosure are known in the art, including address books, auto completion of contact addresses or numbers, and direct address entry. A sender may select a single channel 302, or may indicate a dynamic rule 303 to apply. In this example, the selectable rules include: send to each recipient by their preferred channel; send to each recipient by all available channels; or send to each recipient according to a prioritized list of channels.

In various embodiments, the level of bandwidth availability for each user is assessed, and the message payload is adjust accordingly. In this way, a user with internet connectivity but low bandwidth may receive text without resorting to the SMS channel. In some embodiments, a mobile application is provided on each users' mobile device to report current bandwidth, allowing for more accurate reporting. In some embodiments, a channel-agnostic user application is provided that receives messages from multiple channels for display to the user.

In some embodiments, data collection from a user is provided. As noted above the sender is agnostic as to what channel is used. However, two-way communication is conducted on whichever channel is used for sending the initial message. The data collected thereby is aggregated and provided to the sender without regard to the channel. The channel information may additionally be logged for later analysis.

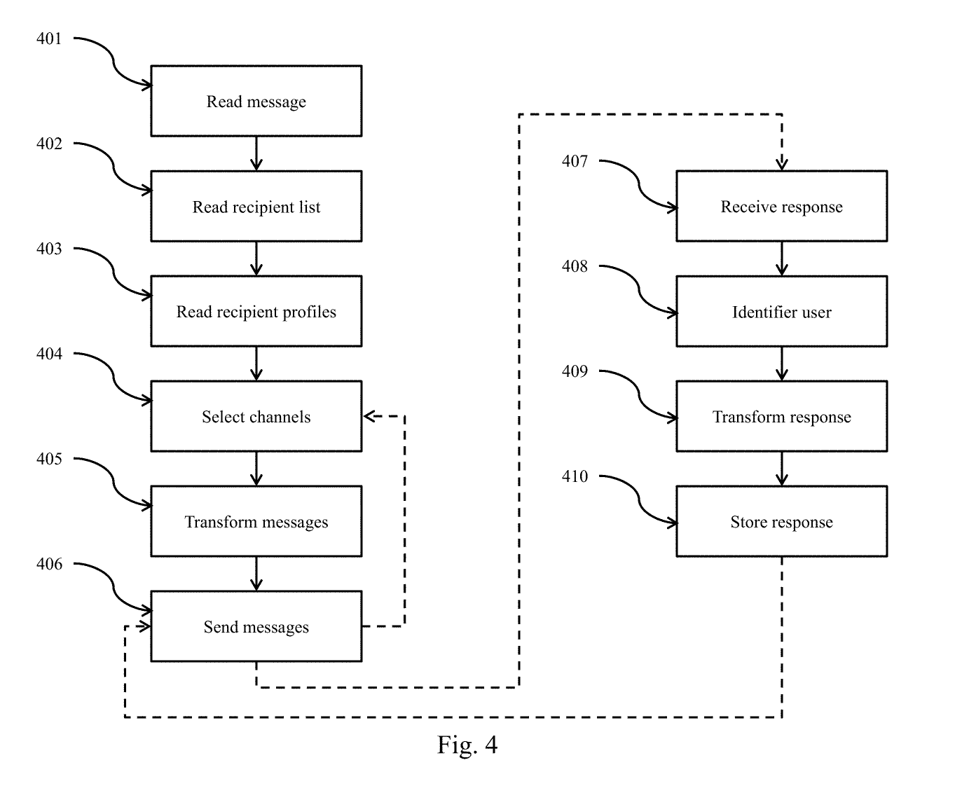

Referring now to FIG. 4, an exemplary method of communication via multiple mobile channels is illustrated according to various embodiments of the present disclosure. At 401, a message is read. In some embodiments, the message comprises text, an image, or a video. In some embodiments, the message is layered such that multiple equivalent components are provided for each element of the message. For example, each image in the message may have equivalent text, and each video in the video may have an equivalent image.

At 402, a list of recipients is read. In some embodiments, the list of recipients is read from a data store such as a database. In some embodiments, the list of recipients is received from a user.

At 403, a user profile is read for each recipient on the list of recipients. In some embodiments, each user profile includes a plurality of channel identifiers for the user. A channel identifier contains information sufficient to send a message to a user via a given channel. For example, a channel identifier for email may be an email address, a channel identifier for SMS may be a mobile phone number, a channel identifier for voice may be a mobile phone or IP phone number, and a channel identifier for a social network or messaging application may be a username or other unique identifier. It will be appreciated that this is not an exhaustive list, and that additional channels and channel identifiers are suitable for use according to the present disclosure.

At 404, a channel is selected for each recipient user. In some embodiments, selecting the channel comprises reading a preferred channel from the user profile. In some embodiments, selecting the channel comprises selecting a channel capable of delivering the message. For example, if the message contains an image, a channel is selected that supports images. In some embodiments, selecting the channel comprises determining the user's current availability via a channel. For example, a channel such as a messaging platform may use queries to determine whether a user is currently active or idle on that channel. It will be appreciated that various messaging platform provide various platform-specific APIs that allow access to user status information such as last active time or last online time. In some embodiments, selecting the channel comprises determining the current bandwidth of a channel.

At 405, the message is transformed for delivery on the selected channel for each user. In some embodiments, transforming the message comprises selectively replacing content with equivalent content that is supported by the channel. For example, images may be replaced by a textual description or a URL for channels that do not support images. In some embodiments, the substitute content is contained in a layered message. In some embodiments, the substitute content is generated from the message. For example, a text message may be transformed to audio via text-to-speech. In another example, a video is transformed to audio by extraction of an audio track. In some embodiments, the transformed messages are supplied to a secondary system such as an interactive voice response system.

At 406, the transformed messages are sent to each recipient user via the selected channel. In some embodiments, if a message failure is detected, a new channel is selected on which the message is again sent.

In some embodiments, one or more user response is collected from recipient users. In such embodiments, at 407, a response is received from a user. The response may be received from the same or a different channel as the one on which the message was sent. The response may be received via an active session, as in an ongoing chat on a messaging platform, or as a standalone message as by SMS. At 408, the user is identified. In embodiments that rely on an ongoing session, the user may be identified from the session. However, in embodiments that include standalone messages, a user-specific token may be included in sent messages and used to identify a user's responses.

At 409, the response is transformed to a normalized form. As above, the transformation may include substituting equivalent content. For example, if a spoken response is received, it may be transformed into text by voice recognition. At 410, the normalized response is stored.

After a response is received, additional message may be sent at 406. In this way, a dialog may be conducted with a recipient user, as with a chatbot on a messaging platform, or a speech transaction with a user via text-to-speech and voice recognition.

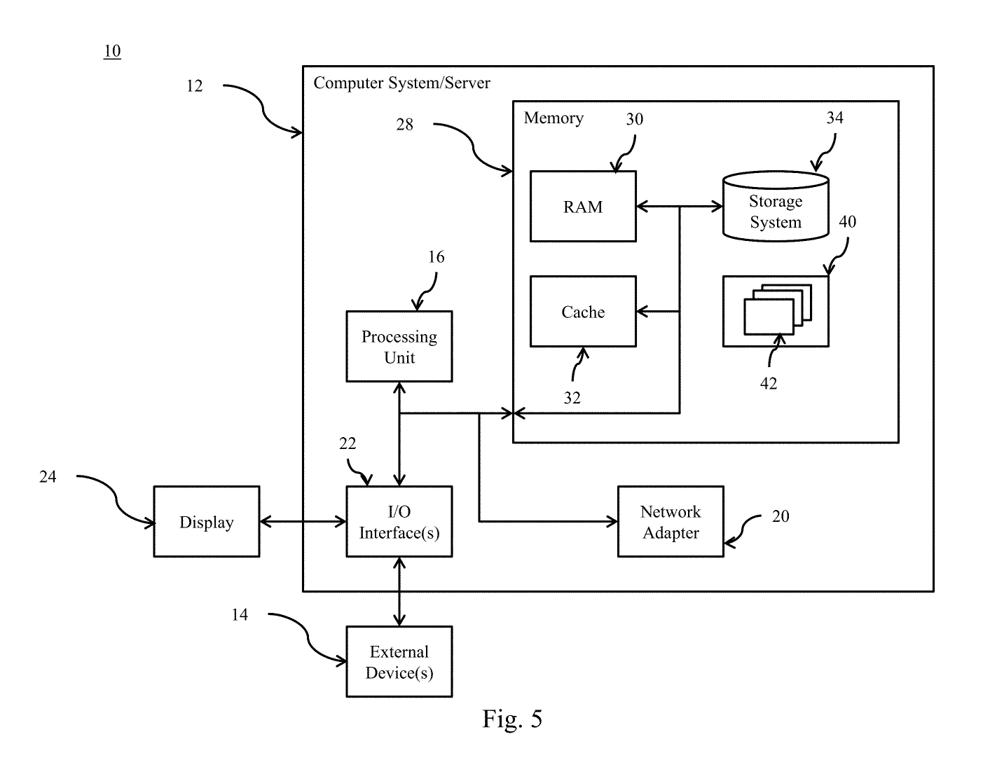

Referring now to FIG. 5, a schematic of an example of a computing node is shown. Computing node 10 is only one example of a suitable computing node and is not intended to suggest any limitation as to the scope of use or functionality of embodiments of the invention described herein. Regardless, computing node 10 is capable of being implemented and/or performing any of the functionality set forth hereinabove.

In computing node 10 there is a computer system/server 12, which is operational with numerous other general purpose or special purpose computing system environments or configurations. Examples of well-known computing systems, environments, and/or configurations that may be suitable for use with computer system/server 12 include, but are not limited to, personal computer systems, server computer systems, thin clients, thick clients, handheld or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

Computer system/server 12 may be described in the general context of computer system-executable instructions, such as program modules, being executed by a computer system. Generally, program modules may include routines, programs, objects, components, logic, data structures, and so on that perform particular tasks or implement particular abstract data types. Computer system/server 12 may be practiced in distributed cloud computing environments where tasks are performed by remote processing devices that are linked through a communications network. In a distributed cloud computing environment, program modules may be located in both local and remote computer system storage media including memory storage devices.

As shown in FIG. 5, computer system/server 12 in computing node 10 is shown in the form of a general-purpose computing device. The components of computer system/server 12 may include, but are not limited to, one or more processors or processing units 16, a system memory 28, and a bus 18 that couples various system components including system memory 28 to processor 16.

Bus 18 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus.

Computer system/server 12 typically includes a variety of computer system readable media. Such media may be any available media that is accessible by computer system/server 12, and it includes both volatile and non-volatile media, removable and non-removable media.

System memory 28 can include computer system readable media in the form of volatile memory, such as random access memory (RAM) 30 and/or cache memory 32. Computer system/server 12 may further include other removable/non-removable, volatile/non-volatile computer system storage media. By way of example only, storage system 34 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 18 by one or more data media interfaces. As will be further depicted and described below, memory 28 may include at least one program product having a set (e.g., at least one) of program modules that are configured to carry out the functions of embodiments of the invention.

Program/utility 40, having a set (at least one) of program modules 42, may be stored in memory 28 by way of example, and not limitation, as well as an operating system, one or more application programs, other program modules, and program data. Each of the operating system, one or more application programs, other program modules, and program data or some combination thereof, may include an implementation of a networking environment. Program modules 42 generally carry out the functions and/or methodologies of embodiments of the invention as described herein.

Computer system/server 12 may also communicate with one or more external devices 14 such as a keyboard, a pointing device, a display 24, etc.; one or more devices that enable a user to interact with computer system/server 12; and/or any devices (e.g., network card, modem, etc.) that enable computer system/server 12 to communicate with one or more other computing devices. Such communication can occur via Input/Output (I/O) interfaces 22. Still yet, computer system/server 12 can communicate with one or more networks such as a local area network (LAN), a general wide area network (WAN), and/or a public network (e.g., the Internet) via network adapter 20. As depicted, network adapter 20 communicates with the other components of computer system/server 12 via bus 18. It should be understood that although not shown, other hardware and/or software components could be used in conjunction with computer system/server 12. Examples, include, but are not limited to: microcode, device drivers, redundant processing units, external disk drive arrays, RAID systems, tape drives, and data archival storage systems, etc.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method comprising:
reading a message;
reading a list of recipients;
reading a profile for each recipient in the list of recipients, each profile comprising at least one channel identifier;
selecting a channel for each recipient in the list of recipients based on its profile;
transforming the message according to the selected channel for each recipient in the list of recipients;
sending to each recipient in the list of recipients the transformed message according to the selected channel.

2. The method of claim 1, wherein the message comprises text, an image, or a video.

3. The method of claim 1, wherein the message comprises a plurality of equivalent message components.

4. The method of claim 1, wherein the at least one channel identifier comprises an email address, a phone number, or a username.

5. The method of claim 1, wherein selecting the channel comprises reading a preferred channel from the user profile of each recipient in the list of recipients.

6. The method of claim 1, wherein selecting the channel comprises determining that the channel supports the message.

7. The method of claim 1, wherein selecting the channel comprises determining that the channel is currently active.

8. The method of claim 1, wherein selecting the channel comprises determining the current bandwidth of the channel.

9. The method of claim 1, wherein transforming the message comprises selectively replacing content with equivalent content that is supported by the selected channel.

10. The method of claim 1, further comprising:
detecting that sending failed to a recipient;
selecting a second channel;
transforming the message according to the second channel;
sending to the recipient the transformed message.

11. The method of claim 1, further comprising:
receiving a response from one of the recipients in the list of recipients;
transforming the response into normalized form;
storing the normalize form.

12. A computer program product for communications via multiple mobile channels, the computer program product comprising a computer readable storage medium having program instructions embodied therewith, the program instructions executable by a processor to cause the processor to perform a method comprising:
reading a message;
reading a list of recipients;
reading a profile for each recipient in the list of recipients, each profile comprising at least one channel identifier;
selecting a channel for each recipient in the list of recipients based on its profile;
transforming the message according to the selected channel for each recipient in the list of recipients;
sending to each recipient in the list of recipients the transformed message according to the selected channel.
